(19) United States
(12) Patent Application Publication
(10) Pub. No.: US 2024/0409766 A1
(43) Pub. Date: Dec. 12, 2024

(54) NONIONIC RESINS, AND MIXTURES OF NONIONIC RESINS WITH CATIONIC ADDITIVES FOR STAIN BLOCKING ARCHITECTURAL COMPOSITIONS

(71) Applicants: Columbia Insurance Company, Omaha, NE (US); BENJAMIN MOORE & CO., Montvale, NJ (US)

(72) Inventors: Yong Yang, Hillsborough, NJ (US); Richard Geurtsen, Robbinsville, NJ (US); Xinyu Wang, Hillsborough, NJ (US); Ajaya Nanda, Flanders, NJ (US)

(21) Appl. No.: 18/689,641

(22) PCT Filed: Jul. 10, 2023
(86) PCT No.: PCT/US2023/027239

§ 371 Date: Mar. 6, 2024

Related U.S. Application Data
(60) Provisional application No. 63/388,080, filed on Jul. 11, 2022.

(51) Int. Cl. C09D 133/06; C08F 220/18; C08K 3/16; C08K 5/092; C08K 5/19; C09D 5/02; C09D 5/16; C09D 7/45; C09D 7/61; C09D 7/63

(52) U.S. Cl. CPC C09D 133/062; C08F 220/1804; C09D 5/022; C09D 5/027; C09D 5/1668; C09D 7/45; C09D 7/61; C09D 7/63; C08F 2800/20; C08K 2003/164; C08K 5/092; C08K 5/19

(57) ABSTRACT

Disclosed herein are nonionic resin compositions that are polymerized without acid monomer or substantially without acid monomer. The nonionic resin compositions are compatible with cationic additives to lock stains. Primer and topcoat paint compositions containing such compositions are resistant to stains migrating to the top of the paint films.

### FIELD OF THE INVENTION

The present invention relates to low VOC, waterborne, stain blocking architectural compositions, including but not limited to, primer or top-coat paint compositions that include a cationic additive(s) admixed with nonionic latex resin(s).

The present invention is also directed to nonionic resin(s).

### BACKGROUND OF THE INVENTION

Certain substrates to be painted such as woods have tannins, which are astringent, polyphenolic biomolecules, which can bleed thorough paint films including the primer paint layer and stain the topcoat paint layer becoming undesirable visible stains on the painted substrates. Other stains include crayons, lipsticks, marker pens, coffee, wine etc. and other stains on walls, and water stains on ceilings that can bleed through paint films.

Conventional solvent-based alkyd coatings are capable of blocking stains, but have odor and high volatile organic component (VOC) emissions. Hydrophobic waterborne acrylic resins have been used to block stains by creating hydrophobic paint film layers. In these hydrophobic waterborne systems, stains would still bleed into the primer layer, and would eventually bleed into the topcoats.

Most stains are anionic in nature and can be locked from migrating by cationic resins in waterborne architectural compositions. Cationic resins limit the mobility of the water-soluble stains in waterborne coating applications. The cationic resins form complexes with the anionic stains in an ion exchange content to render the stains insoluble and trapped or locked in the primer paint film when it dries. However, cationic resins are generally highly hydrophilic and could increase the water sensitivity of architectural compositions and paint films. Increased water sensitivity in cationic coatings can cause loss of wet adhesion, scrub resistance and blistering resistance.

As discussed in U.S. Pat. No. 5,312,863, conventional aqueous latex coatings are generally anionic. The anionic latex polymer binders are generally prepared by aqueous emulsion polymerization techniques using non-ionic and/or anionic surfactants. These anionic latex polymer binders are blended with opacifying pigments, extender pigments and dispersed with anionic pigment dispersants to form waterborne latex coatings or paints. The anionic binders typically contain anionic functional groups such as sulfate and carboxylate groups. Functionalization of these anionic latex polymers with amines, acetoacetate or amides such as ethylene urea derivatives can improve wet adhesion to substrates. The '863 patent and references cited therein are incorporated by reference in their entireties.

However, heretofore cationic resins are not blended or mixed with anionic resins to alleviate the water sensitivity issues associated with cationic resins. Blending or mixing cationic resins with anionic resins would readily cause grit formation or gelation and in general loss of performance and physical properties.

Hence, there remains a need for waterborne formulations that have improved stain resistance and that can resist stains from the substrate from migrating to the topcoats while minimizing the water sensitivity of the paint films.

More specifically, there remains a need for a nonionic resin that is capable of being admixed with cationic additives or other additives that can lock stains from the substrate from migrating to the topcoat.

There remains a need for an improved nonionic resin.

### SUMMARY OF THE INVENTION

Hence, the present invention is directed to novel waterborne architectural compositions that combine cationic additives with novel waterborne compositions that can lock stains.

Preferably, the novel waterborne compositions include nonionic waterborne resin compositions, which act as carriers for the cationic additives or other tannin reactive compounds. The inventive nonionic resin compositions are stable and compatible with the cationic additives.

To avoid the water sensitivity issues associated with cationic resins when used in paints, preferably in embodiments of the present invention, cationic additives are preferably used in place of cationic resins to provide tannin locking function. Preferably, the cationic additives are admixed to the inventive nonionic resins.

The present invention is also directed to inventive nonionic resins. Preferably, the inventive nonionic resins are compatible with cationic additives or tannin reactive compounds.

Advantageously, as disclosed in parent U.S. provisional patent application Ser. No. 63/388,080 filed on 11 Jul. 2022, the inventive nonionic resins are also compatible with cationic resins, such that blending these two resins do not form grit or gel.

Preferably, the inventive nonionic resin is free or substantially free of acid monomers, such as monomers with carboxylic acid, and is free or substantially free of all monomers with anionic groups, such as monomers with phosphate, sulfonate, and other monomers with anionic charge. As used herein, substantially free of monomer(s), e.g., acid monomers and monomers with anionic charge, means that low levels of less than 0.25 wt. %, preferably less than 0.125 wt. %, more preferably less than 0.1 wt. % of total monomer content. More preferably, the inventive nonionic resins contain no acid monomer, i.e., substantially free includes no acid monomer or other monomers with anionic groups.

Without being bound to any particular theory, the present inventors have discovered that polymerization, preferably emulsion polymerization, could be conducted without acid monomer(s) when a polymerizable nonionic hydrophilic component, such as polymerizable poly(ethylene) glycol monomer or polymerizable poly(propylene) glycol monomer, is copolymerized with the film forming monomers, and nonionic surfactant(s) to form micelles. In one embodiment, the only surfactant(s) used to form micelles and latex particles are nonionic surfactant(s).

The nonionic surfactant(s) is preferably present less than about 5 wt. %, preferably from about 1 wt. % to about 4 wt. %, preferably about 1.5 wt. % to about 3.5 wt. %. Alternatively, the nonionic surfactant is present from about 1 wt. % to about 4.5 wt. %, preferably from about 1.25 wt. % to about 4.25 wt. %, and preferably from about 1.5 wt. % to about 3.75 wt. %. The nonionic surfactant preferably has (HLB) values from about 14 to about 18, preferably about 14 to about 17, preferably from about 15 to about 18.

The nonionic polymerizable hydrophilic component, such as methoxypolyethylene glycol methacrylate or methoxypolypropylene glycol methacrylate, is preferably present from 0 wt. % to about 10 wt. % (i.e., less than 10 wt. %), from 0 wt. % to about 5 wt. % (i.e., less than 5 wt. %), or preferably from about 1.5 wt. % to about 3.5 wt. %. Alternatively, the nonionic polymerizable hydrophilic component is present from about 1 wt. % to about 5 wt. %, preferably from about 1.25 wt. % to about 4.5 wt. %, preferably from about 1.5 wt. % to about 3.5 wt. %, preferably from about 1.75 wt. % to about 3.25 wt. %.

In one embodiment, a small amount of anionic surfactant can be substituted for nonionic surfactant in the initial seeding stage to better control particle size of the seed formation. The total amount of anionic surfactant can be from 0 wt. % to about 0.25 wt. %, preferably 0.01 wt. % to about 0.25 wt. %, preferably from about 0.05 wt. % to about 0.15 wt. % based on total monomer content. Alternatively, the anionic surfactant used in the seeding process can range from 0.035 wt. % to about 0.15 wt. % based on total monomer content. Without being bound to any particular theory, the present inventors believe that anionic surfactants are more efficient in controlling particle size, and at low levels anionic surfactants are compatible with latex and cationic paints.

Without being bound to any particular theory, the inventors believe that the seeds being polymerized using anionic surfactant(s) are covered during the polymerization of latex particles by monomers polymerized using nonionic surfactant. In the inventive nonionic latex resins, the seeds formed with anionic surfactant are chemically isolated, and the anionic seeds do not react with cationic latex resins or do not react at a sufficient level to generate grit, gels or other precipitating particles.

Alternatively, the seeds can be polymerized with nonionic surfactant(s) that could produce nonionic latex resins with larger particle sizes. Alternatively, the seeds can be prepared separately, or can be purchased commercially and used in the polymerization.

The percentages for the components of the nonionic resin, described herein, are given as weight percentages of the active ingredients including the weight of the solid monomers and active ingredients of the additives, excluding water.

An embodiment of the present invention is directed to a substantially nonionic latex resin polymerized from:

a monomer mixture comprising at least one nonionic (meth)acrylate monomer, a polymerizable nonionic hydrophilic component, wherein the monomer mixture is substantially free of acid monomer or other monomers with anionic groups, and

a nonionic surfactant ranging from about 1 wt. % to about 4 wt. %, preferably from about 1.5 wt. % to about 3.5 wt. %; and

wherein the polymerizable hydrophilic component is present from about 1.5 wt. % to about 3.5 wt. %,

wherein the weight percentages are without water.

Another embodiment of the present invention is directed to a substantially nonionic latex resin polymerized from:

a monomer mixture comprising at least one nonionic (meth)acrylate monomer, a polymerizable nonionic hydrophilic component, wherein the monomer mixture is substantially free of acid monomer or other monomers with anionic groups, and

a nonionic surfactant ranging from about 1 wt. % to about 4.5 wt. %, preferably from about from about 1.25 wt. % to about 4.25 wt. %, preferably from about 1.5 wt. % to about 3.75 wt. %, wherein a HLB value of the nonionic surfactant ranges from about 14 to about 18, preferably about 14 to about 17, preferably from about 15 to about 18,

wherein the polymerizable hydrophilic component is present from about 1 wt. % to about 5 wt. %, preferably from about 1.25 wt. % to about 4.5 wt. %, preferably from about 1.5 wt. % to about 3.5 wt. %, preferably from about 1.75 wt. % to about 3.25 wt. %,

wherein the weight percentages are without water.

Preferably, the monomer mixture comprises no acid monomer or other monomers with anionic groups. Alternatively, the acid monomer or other monomers with anionic groups are less than 0.25 wt. %, preferably less than 0.125 wt. % of total monomer content.

In one embodiment, the substantially nonionic latex resin is further polymerized with an anionic surfactant in a seeding amount ranging from about 0.01 wt. % to about 0.25 wt. %, preferably from about 0.05 wt. % to about 0.15 wt. % based on total monomer content. Alternatively, the anionic surfactant ranges from about 0.035 wt. % to about 0.15 wt. % based on total monomer content.

Preferably, the polymerizable hydrophilic component comprises a polymerizable polyethylene glycol monomer or a polymerizable polypropylene glycol monomer. In one embodiment, the polymerizable polyethylene glycol monomer is a methoxypolyethylene glycol methacrylate monomer.

Preferably, the nonionic surfactant has a HLB value ranging from about 14 to about 18, preferably about 14 to about 17, preferably from about 15 to about 18.

In some embodiments, only nonionic surfactant is used in the polymerization to form micelles and the substantially nonionic latex resin.

Preferably, the present invention is further directed to paint or architectural compositions comprising the substantially nonionic latex resin described herein, and at least one cationic additive. Preferably, the cationic additive is present from 1.0 wt. % to 6.0 wt. %, preferably from 2.0 wt. % to 4.5 wt. % or from 2.5 wt. % to 3.5 wt. % of the paint or architectural composition, wherein the weight percentage of cationic additive to architectural composition includes water.

Preferably, the cationic additive has at least one positively charged metal ion. The at least one charged metal ion can be an aluminum cation or a zirconium cation or other cations.

The cationic additive may comprise at least one of poly(aluminum hydroxy)chloride, polymeric cationic quaternary amines, a blend of didecyl dimethyl ammonium carbonate and didecyl dimethyl ammonium bicarbonate, aluminum hydroxide, zirconium silicate, ammonium zirconium carbonate, potassium zirconium carbonate, and zinc strontium calcium phosphosilicate.

The paint or architectural compositions preferably further comprise an acid. Preferably, the acid can be a citric acid or a gluconic acid sodium salt. Preferably, the acid is present from about 0.25 wt. % to about 2.0 wt. %, preferably from about 0.5 wt. % to about 1.5 wt. %, or from about 0.7 wt. % to about 1.0 wt. %, wherein the weight percentage of acid to architectural composition includes water.

Another embodiment of the present invention is directed to a method for polymerizing a nonionic resin, wherein the nonionic resin comprises with substantially no acid monomer or with no acid monomer, said method comprises the step of:
polymerizing at least one or more film forming nonionic monomer and a polymerizable hydrophilic component with at least one nonionic surfactant,
wherein a nonionic surfactant ranging from about 1 wt. % to about 4.5 wt. %, preferably from about from about 1.25 wt. % to about 4.25 wt. %, preferably from about 1.5 wt. % to about 3.75 wt. %,
wherein the polymerizable hydrophilic component is present from about 1 wt. % to about 5 wt. %, preferably from about 1.25 wt. % to about 4.5 wt. %, preferably from about 1.5 wt. % to about 3.5 wt. %, preferably from about 1.75 wt. % to about 3.25 wt. %,
wherein the weight percentages are without water.

Optionally, the method further comprises the step of:
preparing a seed for the nonionic resin using a seeding amount of anionic surfactant, wherein the seeding mount ranges from about 0.01 wt. % to about 0.25 wt. %, preferably from about 0.35 wt. % to about 0.15% or from about 0.05 wt. % to about 0.15 wt. % based on total monomer content.

As used in the present invention, “substantially nonionic latex resins” mean nonionic latex resins that are substantially free of acid monomers or monomers with anionic group, and that may include a seeding amount of anionic surfactant used in the seeding phase of the polymerization process to control particle size of the latex resin, as those terms are defined and used herein throughout. Preferably, no acid monomers and no monomers with anionic group are used in the polymerization of nonionic resin.

### BRIEF DESCRIPTION OF THE DRAWINGS

In the accompanying drawings, which form a part of the specification and are to be read in conjunction therewith and in which like reference numerals are used to indicate like parts in the various views:

FIG. 1 is a photograph of four test panels showing tannin stains, conventional primer paints and inventive primer paints, and a topcoat paint.

### DETAILED DESCRIPTION OF THE PREFERRED EMBODIMENTS

While capable of locking up stains and minimizing the stains' ability to migrate through the paint films, due to their hydrophilicity cationic resins can cause water sensitivity problems, such as loss of wet adhesion, decreasing scrub resistance and reduced resistance to blisters. As shown by experiments below, cationic paints and primers when used alone suffer from water sensitivity such as blisters forming on paint films. The present invention resolves this problem by admixing a cationic additive(s) or another tannin reactive compound(s) with novel nonionic resin(s). The inventive nonionic resin compositions are stable and advantageously compatible with cationic additives and tannin reactive compounds, as well as cationic resins.

U.S. Pat. No. 4,981,759 discloses that nonionic acrylic resins may be obtained by (co)polymerizing at least one unsaturated monomer selected according to the properties required from alkyl (meth)acrylates, such as methyl (meth)acrylate, ethyl (meth)acrylate, butyl (meth)acrylate, propyl (meth)acrylate and 2-ethylhexyl (meth)acrylate, hydroxyalkyl (meth)acrylates such as hydroxyethyl (meth)acrylate and hydroxypropyl (meth)acrylate, (meth)acrylic acid, aromatic vinyl compounds such as styrene and its derivatives (e.g., alpha-methylstyrene), (meth)acrylonitrile; and butadiene.

Typical emulsion polymerization such as those described in the '759 patent includes acrylic, vinyl or styrene monomers, and a small amount of acid monomers, such as (meth)acrylic acid, is added to stabilize the polymerization. Generally, without the acid monomer(s) the emulsion processes are not stable and are often not successful. The present inventors have determined that having acid monomers, such as (meth)acrylic acid in the polymerization would render the resulting polymers anionic. Without being bound to any particular theory, it is believed that the side chains on the (meth)acrylic acid in the latex polymer lose proton(s) and become anionic.

Parent U.S. provisional patent application Ser. No. 63/388,080 filed on 11 Jul. 2022 discloses stain blocking architectural compositions utilizing cationic resin and novel nonionic resin blends that can resist the stains' migration through the paint films. This parent patent application is incorporated herein by reference in its entirety.

Without being bound to any particular theory, the present inventors have discovered that polymerization, preferably emulsion polymerization, could be conducted without acid monomer(s) when a polymerizable nonionic hydrophilic component, such as polymerizable poly(ethylene) glycol or polymerizable poly(propylene) glycol is copolymerized with the film forming monomers and the nonionic surfactant(s) is used to form micelles. Preferably, only nonionic surfactant(s) is used to form micelles and latex particles. Another aspect of the present invention is directed to nonionic resin(s) copolymerized substantially without acid monomers and preferably without acid monomers.

In accordance with one aspect of the present invention, the inventive nonionic latex resins are compatible with cationic functional groups. The inventive nonionic latex resins admixed with cationic additives form dry paint films that have tannin blocking properties from the cationic functional groups from the cationic additives and exhibit good film properties, such as blister resistance. The suitable nonionic latex resins also have improved viscosity stability during their shelf-life, discussed below.

In one preferred embodiment of the present invention, acid monomers are preferably omitted or substantially omitted from the polymerization to prevent these moieties on the polymer from becoming anionic. To impart stability to the nonionic polymeric resin, a hydrophilic, nonionic surfactant is utilized in the polymerization. Additionally, a polymerizable nonionic hydrophilic component, such as a polymerizable polyethylene glycol or polypropylene glycol (e.g., a methoxypolyethylene glycol methacrylate (MW of 750 Daltons in 50% in water)) is added to the polymerization.

In a preferred embodiment, in order to seed the polymerization, a small amount of an anionic surfactant is added to the polymerization. This anionic surfactant is preferably the only ionic component in the polymerization and is efficient in seeding the latex polymer. Anionic surfactant, if utilized, is used at the beginning of the polymerization in the seeding phase. Alternatively, nonionic surfactant could be used in the seeding process. Pre-made or commercially available seeds could also be used; monomers are polymerized around these seeds.

In less preferred embodiments, if acid monomer(s) is used at all it is preferably held to less than 0.25 wt. %, preferably less than 0.125 wt. %, and preferably less than 0.1 wt. % and more preferably 0 wt. %.

Preferably, the nonionic surfactant(s) is preferably present from 0 wt. % to about 5 wt. % (less than 5 wt. %), preferably from about 1 wt. % to about 4 wt. %, preferably about 1.5 wt. % to about 3.5 wt. %. Alternatively, the nonionic surfactant is present from about 1 wt. % to about 4.5 wt. %, preferably from about 1.25 wt. % to about 4.25 wt. %, and preferably from about 1.5 wt. % to about 3.75 wt. %. The anionic surfactant, if used, is preferably present from 0 wt. % to about 0.25 wt. %, preferably 0.01 wt. % to about 0.25 wt. %, preferably from about 0.05 wt. % to about 0.15 wt. %. Alternatively, the anionic surfactant used in the seeding process can range from 0.035 wt. % to about 0.15 wt. % based on total monomer content. Preferably, the nonionic polymerizable hydrophilic component is present from 0 wt. % to about 10 wt. % (less than 10 wt. %), from 0 wt. % to about 5 wt. % (less than 5 wt. %), or from about 1.5 wt. % to about 3.5 wt. %. Alternatively, the nonionic polymerizable hydrophilic component is preferably present from about 1 wt. % to about 5 wt. %, preferably from about 1.25 wt. % to about 4.5 wt. %, preferably from about 1.5 wt. % to about 3.5 wt. %, preferably from about 1.75 wt. % to about 3.25 wt. %. The percentages for the components of the non-ionic resin are given as weight percentages of the active ingredients including the weight of the solid monomers and active ingredients of the additives.

A ratio between the nonionic surfactant to nonionic polymerizable hydrophilic component is preferably 1 to 1 by weight, and up to 1.5 or 2.0 or 3 wt. parts of nonionic surfactant to 1 wt. part nonionic polymerizable hydrophilic component.

EXAMPLE 1. An exemplary inventive nonionic resin without acid monomer. The reactor seeding was added into a nitrogen purged 4-neck reactor followed by a temperature increase to 60° C. Next, 30 g of the premixed monomer emulsion was added to the reactor followed by redox initiators, oxidizing agent t-butyl hydroperoxide (70%) and reducing agent Bruggolite® FF6 M solution The mixture was then allowed to react for 15 minutes. The remaining monomer emulsion, oxidizing agent solution, and reducing agent solution were fed to the reactor simultaneously over a period of 3.5 hours. 15 grams of water was used to rinse monomer emulsion flask. The latex formed in the reactor was kept at 60° C. for 1 hour. The reactor was cooled to 25° C. followed by addition of the biocide solution. The non-ionic latex binder has a Flory-Fox glass transition temperature of −2° C. and a measured minimum film formation temperature of 0° C. The particle size is 242 nanometers. (Unless noted otherwise, particle sizes of the latex particles are mean volume.) The solid content is 40.6%. In Example 1, the initiators are a redox pair (tBHP and Bruggolite FF6M).

| | Weight | Solids | % solid/ |
|---|---|---|---|
| Components | (gram) | (gram) | Total solids |
| Reactor Seeding | | | |
| Water | 600 | | |
| Non-ionic surfactant Abex 252/40 | 3 | 1.2 | 0.15% |
| (40%) | | | |
| Monomer Emulsion | | | |
| Water | 290 | | |
| Non-ionic surfactant Abex 252/40 | 48 | 19.2 | 2.45% |
| (40%) | | | |
| Polyethylene glycol methacrylate | 30 | 15 | 1.92% |
| (MW = 750) (50%) | | | |
| Butyl acrylate | 351.4 | 351.4 | 44.89% |
| 2-ethylhexyl acrylate | 329.8 | 329.8 | 42.13% |
| Methyl methacrylate | 60.3 | 60.3 | 7.7% |
| Seed oxidizing agent | | | |
| t-butyl hydroperoxide (70%) | 1.5 | 0 | |
| Seed reducing agent solution | | | |
| Bruggolite ® FF6 M | 1.5 | 1.5 | 0.19% |
| Water | 15.2 | | |
| Oxidizing agent solution | | | |
| t-butyl hydroperoxide (70%) | 4.22 | 0 | |
| Water | 80 | | |
| Reducing agent solution | | | |
| Bruggolite ® FF6 M | 4.37 | 4.37 | 0.56% |
| Water | 83 | | |
| Water (Rinse) | 15 | | |
| Biocide Solution | | | |
| Biocide | 1 | 0 | |
| Water | 5 | 0 | |
| Total | 1923.3 | 782.8 | 100% |

EXAMPLE 2. Another exemplary inventive nonionic resin without acid monomer. The reactor seeding was added into a nitrogen purged 4-neck reactor followed by a temperature increase to 80° C. Next, 31 g of the premixed monomer emulsion was added to the reactor followed by seed initiator solution. The mixture was then allowed to react for 15 minutes. The remaining monomer emulsion, fed to the reactor simultaneously over a period of 3.5 hours. 30 grams of water was used to rinse monomer emulsion flask. The latex formed in the reactor was kept at 80° C. for 1 hour. The reactor was cooled to 60° C. followed by simultaneously feeding of t-butyl hydroperoxide and Bruggolite® FF6 M solutions over 30 minutes. The reactor was then cooled to room temperature and the biocide solution was added. The non-ionic latex binder has a Flory-Fox glass transition temperature of −2° C. and a measured minimum film formation temperature of 0° C. The particle size of the latex is 249 nanometers. The solid content is 42.6%. In Example 2, the initiator is sodium persulfate.

| | Weight | Solids | % solid/ |
|---|---|---|---|
| Components | (gram) | (gram) | Total solids |
| Reactor Seeding | | | |
| Water | 600 | | |
| Non-ionic surfactant ethoxylated | 1.5 | 1.2 | 0.15% |
| tridecyl alcohol (80%) | | | |
| Sodium bicarbonate | 1 | 1 | 0.13% |
| Monomer Emulsion | | | |
| Water | 290 | | |
| Ethoxylated tridecyl alcohol | 24.3 | 1.07 | 2.48% |
| (80%) | | | |
| Polyethylene glycol methacrylate | 30 | 15 | 1.91% |
| MW = 750 (50%) | | | |
| Butyl acrylate | 350.9 | 350.9 | 44.73% |
| 2-ethylhexyl acrylate | 331.7 | 331.7 | 42.29% |
| Methyl methacrylate | 60.3 | 60.3 | 7.69% |
| Seed Initiator solution | | | |
| Sodium persulfate | 1.3 | 1.3 | 0.17% |
| Water | 15 | | |
| Delay Initiator Solution | | | |
| Sodium persulfate | 0.6 | 0.6 | 0.08% |
| Water | 10 | | |
| Bruggolite ® FF6 M | 1.5 | 1.5 | 0.19% |
| Water | 15.2 | | |
| Chaser | | | |
| t-butyl hydroperoxide (70%) | 1.5 | 0 | |
| Water | 20 | | |
| Reducing agent solution | | | |
| Bruggolite ® FF6 M | 1.5 | 1.5 | 0.19% |
| Water | 20 | | |
| Water (Rinse) | 30 | | |
| Biocide Solution | | | |
| Biocide | 1 | | |
| Water | 5 | | |
| Total | 1812.3 | 784.4 | 100.0 |

EXAMPLE 3A. Another exemplary inventive nonionic resin without acid monomer. Example 3A is disclosed in parent U.S. provisional patent application Ser. No. 63/388,080. The weight percentages reported in this Example do not include water. Typically, MPEG 750 MA is available in a 50% aqueous solution, and the (meth)acrylate monomers are available as 40-42 wt. % solids in aqueous solutions. A small amount of anionic surfactant is added into Example 3A to seed the polymerization. No acid monomer is copolymerized, and sodium persulfate is the initiator.

| | |
|---|---|
| Materials | Weight % |

Buffer

| | |
|---|---|
| Sodium bicarbonate | 0.12 |

Surfactants

| | |
|---|---|
| Nonionic surfactant | 2.86 |
| Anionic surfactant -- ammonium | 0.05 |
| phosphate, polyoxyethylene | |
| tridecyl ether | |

Monomers

| | |
|---|---|
| methoxypolyethylene glycol | 2.76 |
| methacrylate (MPEG 750 MA) | |
| butyl acrylate (BA) | 42.31 |
| methyl methyacrylate (MMA) | 39.33 |
| 2-ethyl hexyl acrylate (2-EHA) | 7.20 |
| acetoacetoxyethyl methacrylate | 4.78 |
| (AAEM) | |

Initiator

| | |
|---|---|
| Sodium Persulfate (Na₂S₂O₈) | 0.22 |

Chaser

| | |
|---|---|
| t-butyl hydroperoxide (tBHp) | 0.13 |
| Bruggolite FF6M | 0.18 |

Biocide

| | |
|---|---|
| Biocide | 0.06 |

EXAMPLE 3B is similar to Example 3A, except that it utilized more nonionic surfactant in the polymerization process.

| | |
|---|---|
| Materials | Weight % |

Buffer

| | |
|---|---|
| Sodium bicarbonate | 0.12 |

Surfactants

| | |
|---|---|
| Nonionic surfactant | 3.57 |
| Anionic surfactant - ammonium | 0.05 |
| phosphate, polyoxyethylene | |
| tridecyl ether | |

Monomers

| | |
|---|---|
| methoxypolyethylene glycol | 2.07 |
| methacrylate (MPEG 750 MA) | |
| butyl acrylate (BA) | 42.65 |
| methyl methyacrylate (MMA) | 38.97 |
| 2-ethyl hexyl acrylate (2-EHA) | 7.20 |
| acetoacetoxyethyl methacrylate | 4.78 |
| (AAEM) | |

Initiator

| | |
|---|---|
| Sodium Persulfate (Na₂S₂O₈) | 0.22 |

Chaser

| | |
|---|---|
| t-butyl hydroperoxide (tBHp) | 0.13 |
| Bruggolite FF6M | 0.18 |

Biocide

| | |
|---|---|
| Biocide | 0.06 |

In Examples 3A and 3B, the glass transition temperature (Tg) range for the nonionic resin is from about −5° C. to about 15° C., preferably from about −5° C. to about 5° C., as calculated with Fox's equation with a typical value of 1° C. to 10° C. The Fox calculation may omit small components, e.g., less than 3 wt. %, that don't have readily available Tg values, such as the poly(ethylene or propylene) oxide or wet adhesion monomers. The minimum film forming temperature (MFFT) ranges from about −2° C. to about 2° C., preferably about −2° C. to about 6° C. as determined by ISO 2115 standard. The particle size is from about (mean volume, mV) is about 155 nm to about 175 nm, and the pH is about 5 to about 6.

EXAMPLE 4. Another exemplary inventive nonionic resin without acid monomer. The nonionic resin was prepared with the same process as in the Example 2, except that
1.5 grams of ethoxylated tridecyl alcohol was replaced by 3.3 grams of anionic phosphate ester surfactant (25% solids) for seeding, and
the seeding monomer mixture does not contain polyethylene glycol methacrylate. Polyethylene glycol methacrylate was added to monomer emulsion after seeding monomer mixture was charged to the reactor.

The anionic surfactant makes up 0.11 wt. % (solid); the nonionic surfactant makes up 2.48 wt. % (solid); and the polyethylene glycol methacrylate makes up 1.91 wt. % (solid). The polymer has a particle size of 164.9 nanometers. The polymer has a Flory-Fox glass transition temperature of −2° C. and a measured minimum film formation temperature of 0° C. It has a solid content of 40.6%. Sodium persulfate is the initiator.

EXAMPLE 5. Another exemplary inventive nonionic resin without acid monomer. The nonionic copolymer resin was made similar to that of Example 4, except that 80 grams of DAAM crosslinking monomer was added to the monomer mixture. The anionic surfactant makes up 0.10 wt. % (solid); the nonionic surfactant makes up 2.25 wt. % (solid); and the polyethylene glycol methacrylate makes up 1.74 wt. % (solid). The resin has a particle size of 168 nm and a solid content of 43.6%.

EXAMPLE 6. Another exemplary inventive nonionic resin without acid monomer. The nonionic copolymer was made similar to that of Example 5, except that 80 grams of DAAM was replaced by 80 grams of AAEM crosslinking monomer. The anionic surfactant makes up 0.10 wt. % (solid); the nonionic surfactant makes up 2.25 wt. % (solid); and the polyethylene glycol methacrylate makes up 1.74 wt. % (solid). The resin has a particle size of 161 nm and a solid content of 44.0%.

A summary of some of the components from Examples 1-6 and the particle sizes are listed below.

| Wt. % | Ex. 1 | Ex. 2 | Ex. 3A | Ex. 3B | Ex. 4 | Ex. 5 | Ex. 6 |
|---|---|---|---|---|---|---|---|
| Nonionic Surfactant | 2.6% | 2.63% | 2.86% | 3.57% | 2.48% | 2.25% | 2.25% |
| Anionic Surfactant | 0% | 0% | 0.05% | 0.05% | 0.11% | 0.10% | 0.10% |
| MPEG | 1.92% | 1.91% | 2.76% | 2.07% | 1.91% | 1.74% | 1.74% |

| | | | | | | |
|---|---|---|---|---|---|---|
| PS (mV) | 242 nm | 249 nm | 155-175 nm | 165 nm | 168 nm | 161 nm |

As shown in Examples 1-6, the particle sizes (mV) in the nonionic latex particles can be controlled better when during the seeding process anionic surfactant was used (Examples 3A, 3B, 4, 5 and 6) than when nonionic surfactant was used in the seeding process (Examples 1 and 2).

It is noted that in Examples 1-6 the weight percentages as reported are based on all solids. The weight percentages based on total monomer content for the surfactants, or for the MPEG can be readily calculated by excluding the minor solids, i.e., buffer, initiator, chaser and biocide. The surfactants would be included in the percentage calculation, since a weight percentage of a surfactant based on total monomer content is being determined. The weight percentage based on total monomer content and the weight percentage based on total solids are essentially the same.

In the resin Examples 1-6, the nonionic surfactants have HLB values of 14.5 or 16.3. Preferred HLB values range from about 14 to about 18, preferably from about 14 to about 17, preferably from about 15 to about 18. Without being bound to any particular theory, higher hydrophilicity is needed to stabilize the latex particles, because there is no static stabilization due to the non-ionic nature of these latexes.

In accordance with one aspect of the present invention, a cationic additive(s) is admixed with the nonionic latex resins, preferably one or more of the inventive Examples 1-6. The cationic additives react with the tannins and lock the tannins to minimize or prevent the migration of the tannin stains to the topcoat of the paint films, and the inventive nonionic latex resin(s) provides good water resistance, such as blister resistance, to the paint films.

Suitable cationic additives include those that have positively charged metal ions such as aluminum or zirconium cations. Such cations chelate to the side phenolic groups in tannin. Suitable cationic additives include but are not limited to poly(aluminum hydroxy)chloride (PAC) (also known as poly(aluminum chloride)), as tested in Examples 7, discussed below.

PACs are inorganic chemicals generally used as coagulants for wastewater treatment. PACs are reactive to tannins and are capable of locking the tannins. PACs are available commercially through Kemira under the tradename PAX. Commercial PACs are available with different contents of aluminum, aluminum oxide, chlorine, and at various basicity. Exemplary PACs are PAX-14, PAX-18, PAX-XL6, PAX-XL8 AND PAX-XL19, and their properties are listed below.

| | Al | Al2O3 | Cl | Solid | Basicity |
|---|---|---|---|---|---|
| Name | (%) | (%) | (%) | (%) | (%) |
| PAC1 (PAX-14) | 7.1 | 13.4 | 21.0 | 41.5 | 25.5 |
| PAC2 (PAX-18) | 9.0 | 17.0 | 21.0 | 47.0 | 35.8 |
| PAC3 (PAX-XL6) | 5.3 | 10.0 | 11.3 | 29.6 | 54.3 |
| PAC4 (PAX-XL8) | 5.7 | 10.8 | 11.3 | 29.5 | 63.6 |
| PAC5 (PAX-XL19) | 12.6 | 23.7 | 8.3 | 44.6 | 84.2 |

As used herein, basicity is used for its known definition to those of ordinary skill in the art. Acidity and basicity of compounds are indications of pH. Acidity of a medium is caused by acidic compounds, which can release hydrogen ions (H⁺), resulting in a low pH in that medium. Basicity of a medium is caused by basic compounds, which can release hydroxide ions (OH⁻), resulting in a high pH in that medium. Acidity causes a low pH whereas basicity causes a high pH in an aqueous medium.

Suitable cationic additives also include cationic flocculants, which are polymeric cationic quaternary amines (CQA) and are commercially available as Kemira Superfloc C572, C573, C569 and C-4007. C572, C573 and C-4007 have lower molecular weight and C569 is a medium molecular polymeric quaternary amines.

Suitable cationic additives also include organic catanionic compounds that are reactive to tannins, such as a blend of didecyl dimethyl ammonium carbonate and didecyl dimethyl ammonium bicarbonate, which is commercially available as Carboshield® 1000. This is a non-chlorine quaternary that can be used as a corrosion inhibitor or a cationic surfactant.

Additional suitable cationic additives include aluminum hydroxide, zirconium silicate, ammonium zirconium carbonate, potassium zirconium carbonate, zinc strontium calcium phosphosilicate. Commercially available cationic additives are available as Halox XTAIN A pigments and WPC tannin blockers.

In EXAMPLES 7, various dry paint films from different paints/architectural compositions painted over cedar plank surfaces that contain stains were tested. Contrast ratio readings were taken over the stained and unstained areas. Δb* measurements were taken over the stained areas for each paint film. The dry paint films were also inspected for blisters. Inventive Example 7.E utilized the nonionic resin from Example 3 and a tannin reactive compound poly(aluminum hydroxy)chloride. Inventive Example 7.E is compared to comparative Examples 7.A to 7.D. The results are shown below.

### Examples 7.A. to 7.E

| Description of | C/R - | C/R - | Δb* | |
|---|---|---|---|---|
| Tested Paint | Primer | With | (yellowness) | Blistering |
| Compositions | Only | Topcoat | Primer Only | Resistance |
| 7.A. Conventional | 79.5 | 90.1 | 5.14 | 4 |
| Anionic Stain | | | | |
| Blocking Polymer | | | | |
| 7.B. Cationic | 98.4 | 99.7 | 1.66 | 1.5 |
| Resin I only | | | | |
| 7.C. Cationic | 99.6 | 100.1 | 1.91 | 1 |
| Resin II only | | | | |
| 7.D. Benchmark: | 97.8 | 99.5 | 2.52 | 4 |
| Waterborne | | | | |
| Commercial Primer | | | | |
| 7.E (Inventive) | 94.0 | 98.8 | 3.57 | 5 |
| Non-ionic Resin | | | | |
| with poly(aluminum | | | | |
| hydroxy)chloride | | | | |
| (PAX-XL19) | | | | |
| (3.4 wt. %) | | | | |

The cationic resin I used in this experiment is a commercial waterborne emulsion polymerized resin. Cationic Resin II is a commercial waterborne hydrophilic solution polymerized resin. The cationic resins contain about 57% water. The nonionic resin is discussed in Example 3 and contains about 59% water.
C/R is the contrast ratio. The contrast ratio is the ratio of the Y value of the paint over the stained region divided by the luminance (Y) value of the paint color over the unstained region. The best C/R score is theoretically 100.
Δb* is the measurements of yellowness by a spectrophotometer to measure the intensity of light at certain wavelengths, e.g., the wavelengths for the color yellow. A higher reading means more stain.
The blistering resistance is tested at 90° C., and scale is 1-5, with 1 being worst and 5 being the best.

The results from Examples 7A-E show that conventional anionic stain blocking paint (Example 7.A) has acceptable resistance to blistering, i.e., good wet adhesion property, but poor stain blocking abilities, as compared to the benchmark Example 7.D. Conventional paints utilizing cationic resins (Examples 7.B and 7.C) show good stain blocking abilities, as compared to the benchmark, but poor blistering resistance.

Inventive Example 7.E includes 3.4 wt. % of a poly(aluminum hydroxy)chloride additive shows both good stain blocking resistance and excellent blistering resistance. Additional inventive Examples using the inventive nonionic polymeric resins discussed herein and cationic additives were conducted and discussed below. The present inventors note that the in-house blistering resistance test is rigorously conducted at 90° C., which far exceeds the environment conditions that paints and other architectural compositions would be exposed to. Although, the high pass (5.0 score) of inventive Example 7.E shows that inventive paints' enhanced abilities to resist blisters at high temperatures, the present invention is not limited to any blistering scores. Inventive paints exhibit good tannin resistant property, and no grit or gel were formed when the cationic additives are mixed with the inventive nonionic resins.

EXAMPLES 8. Inventive Paint Examples 8.A-8.E were prepared with the nonionic resin from Example 1 and the polymeric cationic quaternary amines (CQA) and the blend of didecyl dimethyl ammonium carbonate and didecyl dimethyl ammonium bicarbonate (DDAMC), as shown below.

| Ingredients | (grams) | 8.A | 8.B | 8.C | 8.D | 8.E |
|---|---|---|---|---|---|---|
| Add the following ingredients | | | | | | |
| to grinding tank: | | | | | | |
| WATER | 150.0 | | | | | |
| Under agitation with 500 rpm | | | | | | |
| Add | | | | | | |
| NUOSEPT 498 | 2.0 | | | | | |
| TEGO DISPERS 750 W | 8.0 | | | | | |
| TRITON CF-10 | 1.5 | | | | | |
| FOAMASTER MO 2184 | 1.2 | | | | | |
| TiO2 | 150.0 | | | | | |
| OPTIWHITE P | 156.8 | | | | | |
| Increase RPM to 1800 for 10 | | | | | | |
| min, then reduce RPM to 800, | | | | | | |
| add | | | | | | |
| IGEPAL CA 630 | 2.0 | | | | | |
| POLYPHASE 663 | 2.5 | | | | | |
| Cationic Additive | 30 | CQA1 | CQA2 | CQA3 | CQA4 | DDAMC |
| WATER | 20.0 | | | | | |
| Letdown phase | | | | | | |
| Polymer of Example 1 | 486.3 | | | | | |
| HEUR High Sheer Thickener | 10.0 | | | | | |
| Associative Polyether Low | 7.0 | | | | | |
| Shear thickener | | | | | | |
| WATER | 54.3 | | | | | |
| Defoamer DREWPLUS L-475 | 5.0 | | | | | |
| FOAM | | | | | | |
| Defoamer BYK-022 | 0.5 | | | | | |
| Total (grams) | 1057.1 | | | | | |

CQA1 has medium molecular weight; CQA2, CQA3 AND CQA4 have low molecular weight.

The weight percentage of the cationic additive in Examples 8 including water is 2.83 wt. %. The tannin blocking paints from Examples 8 were painted over cedar plank surfaces which have a dark tannin stain band from a concentrated tannin solution. A commercial topcoat paint was applied over the tannin blocking paints from Examples 8. A commercial anionic and cationic paint was applied over the cedar planks for comparison. After the paints were dried, optical measurements using an optical spectrophotometer were taken. The results are shown below.

| Paints | Contrast Ratio | Δb* |
|---|---|---|
| Paint 8.A | 0.99 | 0.06 |
| Paint 8.B | 0.95 | 2.33 |
| Paint 8.C | 0.96 | 2.20 |
| Paint 8.D | 0.94 | 2.74 |
| Paint 8.E | 0.94 | 2.20 |
| Commercial anionic paint | 0.76 | 6.53 |
| Commercial cationic paint | 0.97 | 1.86 |

As discussed in connection with Examples 7, higher C/R values and lower Δb* values indicate better tannin blocking properties.

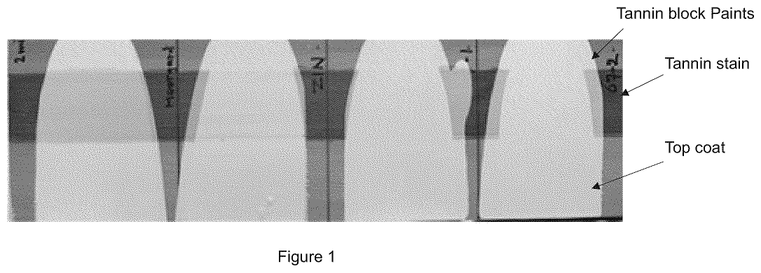

The photo in FIG. 1 shows an exemplary tanning blocking test. First, a concentrated tannin is applied as a strip onto a cedar board. Primer paints are then applied with a 3-mil draw down bar over the tannin stains. After drying for 1 day, a commercial topcoat paint is applied on the top of the primer, albeit on a smaller area. After the topcoat paints dried, contrast ratio (CR) and yellowness Δb* are measured on the topcoat paints from the tannin-stained area and the non-tannin-stained area. On the four panels shown in FIG. 1, the leftmost panel has a commercial anionic primer and a topcoat of a commercial anionic paint. The next left panel has a commercial cationic primer paint and the same commercial anionic topcoat. The two right panels have primer paint 8.D, and the same commercial anionic topcoat on both right panels. Tannin stains may still be visible on the primer paints (“tannin block paints”). However, they are “locked” on the panels with the inventive primer paints 8.D and the stains are not visible on the topcoat. On the other hand, stains are visible on the topcoats in the two left panels with conventional primers.

The tanning blocking properties of the paints in Examples 8 are better than those of the commercial anionic paint and are similar to those of the commercial cationic paint. As shown in Examples 7, commercial cationic paints have poor water resistance and would readily blister.

EXAMPLES 9. Inventive Paint Examples 9.A-9.E were prepared with the nonionic resin from Example 1 and cationic additives, PAC1-PCA5, as shown below.

| Ingredients | (grams) | 9.A | 9.B | 9.C | 9.D | 9.E |
|---|---|---|---|---|---|---|
| Add the following ingredients | | | | | | |
| to grinding tank: | | | | | | |
| WATER | 150.0 | | | | | |
| Under agitation with 500 RPM, | | | | | | |
| add | | | | | | |
| NUOSEPT 498 | 2.0 | | | | | |
| TEGO DISPERS 750 W | 8.0 | | | | | |
| TRITON CF-10 | 1.5 | | | | | |
| FOAMASTER MO 2184 | 1.2 | | | | | |
| TIONA 826 (TiO2) | 150.0 | | | | | |
| OPTIWHITE P | 156.8 | | | | | |
| Increase RPM to 1800 for 10 | | | | | | |
| min, then reduce RPM to 800, | | | | | | |
| add | | | | | | |
| IGEPAL CA 630 | 2.0 | | | | | |
| POLYPHASE 663 | 2.5 | | | | | |
| Poly(aluminum hydroxy)chloride | 30 | PAC1 | PAC2 | PAC3 | PAC4 | PAC5 |
| WATER | 20.0 | | | | | |
| Letdown | | | | | | |
| Polymer of Example 2 | 486.3 | | | | | |
| HEUR High Sheer Thickener | 10.0 | | | | | |
| Associative Polyether Low | 7.0 | | | | | |
| Shear thickener | | | | | | |
| WATER | 54.3 | | | | | |
| Defoamer DREWPLUS L-475 | 5.0 | | | | | |
| FOAM | | | | | | |
| Defoamer BYK-022 | 0.5 | | | | | |
| Total (grams) | 1087.1 | | | | | |

The weight percentage of the cationic additive in Examples 8 including water is 2.76 wt. %. The tannin blocking tests were conducted in the same manner as Examples 8, and the results are shown below.

| Paints | Contrast Ratio | Δb* |
|---|---|---|
| Example 9.A | 0.97 | 0.87 |
| Example 9.B | 0.97 | 0.89 |
| Example 9.C | 1.00 | 0.17 |
| Example 9.D | 1.00 | 0.03 |
| Example 9.E | 1.00 | 0.11 |
| Commercial anionic paint | 0.76 | 6.53 |
| Commercial cationic paint | 0.99 | 0.47 |

The tanning blocking properties of the paints in Examples 9 are better than those of the commercial anionic paint and are similar to those of the commercial cationic paint.

Inventive Examples 8.A-8.E and inventive Examples 9.A-9.E have comparable or better tannin blocking properties as the commercial cationic paint, and significantly better tanning blocking properties than the commercial anionic paint. Examples 7.A-7.E show the same results and that inventive Example 7.E has good blistering resistance.

It appears that the cationic additives tested in Examples 7-9, i.e., poly(aluminum hydroxy)chloride at various concentrations of aluminum, aluminum oxide and chlorine (PAC), polymeric cationic quaternary amines at various molecular weights (CQA), and blend of dodecyl dimethyl ammonium carbonate/bicarbonate, perform well in blocking tannin migration or bleeding relative to each other. It is expected that the other cationic additives, including but not limited to those listed herein would perform equally well, when admixed with the inventive nonionic latex resins described herein.

Preferably, the cationic additives are added to the paints/architectural composition utilizing the inventive nonionic latex resin(s) from 1.0 wt. % to 6.0 wt. %, preferably from 2.0 wt. % to 4.5 wt. %, and preferably from 2.5 wt. % to 3.5 wt. %. The weight percentage of cationic additive to architectural composition includes water in the calculation.

Conventional cationic paints are less compatible with most raw materials used in coatings, resulting in flocculation. The inventive paints made with the inventive non-ionic resins and cationic additives are compatible without flocculation. There is still a tendency for most cationic paints to gradually increase their viscosity over time.

In accordance with another aspect or embodiment of the present invention, an acid is added to the inventive paint to maintain the paint's viscosity.

EXAMPLES 10. Paint Examples 10.A and 10.B were made with the same ingredients and process as Example 9.E with additional ingredients added to improve viscosity stability over time. More specifically, Example 10.A includes 9.5 grams of citric acid, and Example 10.B includes 9.5 grams of gluconic acid sodium salt, which represents 0.87 wt. % including water (9.5 g÷(1087.1 g+9.5 g)). The results are shown below.

| | Initial | Viscosity after 2 | |
|---|---|---|---|
| | viscosity | weeks incubation | Δ viscosity |
| Paints | (KU) | at 120 F. (KU). | (KU) |
| Paint 9.E | 104 | 135 | 31 |
| Paint 10.A | 101 | 99 | −2 |
| Paint 10.B | 100 | 101 | 1 |

Preferably, the acid(s) is added to the nonionic paints/architectural composition admixed with cationic additive(s) from 0.25 wt. % to 2.0 wt. %, preferably from 0.5 wt. % to 1.5 wt. %, and more preferably from 0.7 wt. % to 1.0 wt. %. The weight ratios of acid to architectural composition includes water in the calculation.

Exposure Experiments. Wooden planks painted commercial primer paints and with primer paint blends of the inventive nonionic resin and cationic resin were left outdoors for two years to test the longevity of the paints. Some of the painted planks were held in the horizontal position and some held in a substantially 450 angle orientation facing South. Some of the planks were also painted with a topcoat layer. Most of the primer paints held up well, and all of the primer and topcoat paints held up well. Growth of microbial organism was observed on planks painted with only commercial primer paints. Less growth or no growth was observed on planks painted with a blend of the inventive nonionic resin and cationic resin. The planks painted with a blend of the inventive nonionic resin and cationic resin performed better than the planks painted with the benchmark primer and a commercial primer at resisting microbial growth. The planks painted with a blend of the inventive nonionic resin and cationic resin performed better than the planks painted with the benchmark primer at water sensitivity and adhesion with less cracking and peeling on the horizontal positioned planks.

Generally, any (meth)acrylic monomers can be used in the present invention. Suitable (meth)acrylic monomers include, but are not limited to methyl (meth)acrylate, ethyl (meth)acrylate, butyl (meth)acrylate, iso-octyl (meth)acrylate, lauryl (meth)acrylate, 2-ethylhexyl (meth)acrylate, stearyl (meth)acrylate, isobornyl (meth)acrylate, methoxyethyl (meth)acrylate, 2-ethyoxyethyl (meth)acrylate, 2-hydroxyethyl (meth)acrylate, 2-hydroxybutyl (meth)acrylate, dimethylamino ethyl (meth)acrylate, diethylaminoethyl (meth)acrylate, dimethylaminopropyl (meth)acrylamide, alkyl (meth)acrylic acids, such as methyl (meth)acrylate acids, (meth)acrylic acids, wet adhesion monomers, such as N-(2-methacryloyloxyethyl)ethylene urea, and multifunctional monomers such as divinyl benzene, diacrylates, for crosslinking functions etc., acrylic acids, ionic acrylate salts, alkacrylic acids, ionic alkacrylate salts, haloacrylic acids, ionic haloacrylate salts, acrylamides, alkacrylamides, monoalkyl acrylamides, monoalkyl alkacrylamides, alkyl acrylates, alkyl alkacrylates, acrylonitrile, alkacrylonitriles, dialkyl acrylamides, dialkyl alkacrylamides, hydroxyalkyl acrylates, hydroxyalkyl alkacrylates, only partially esterified acrylate esters of alkylene glycols, only partially esterified acrylate esters of non-polymeric polyhydroxy compounds like glycerol, only partially esterified acrylate esters of polymeric polyhydroxy compounds, itaconic acid, itaconic mono and di-esters, and combinations thereof. The preferred alkyl (meth)acrylate monomers are methyl methacrylate and butyl acrylate.

Preferred monomers containing aromatic groups are styrene and α-methylstyrene. Other suitable monomers containing aromatic groups include, but are not limited to, 2,4-diphenyl-4-methyl-1-pentene, 2,4-dimethylstyrene, 2,4,6-trimethylstyrene, 2,3,4,5,6-pentafluorostyrene, (vinylbenzyl)trimethylammonium chloride, 2,6-dichlorostyrene, 2-fluorostyrene, 2-isopropenylaniline, 3(trifluoromethyl)styrene, 3-fluorostyrene, α-methylstyrene, 3-vinylbenzoic acid, 4-vinylbenzyl chloride, α-bromostyrene, 9-vinylanthracene, and combinations thereof.

Preferred monomers containing primary amide groups are (meth)acrylamides. Suitable monomers containing amide groups include, but are not limited to, N-vinylformamide, or any vinyl amide, N,N-dimethyl(meth)acrylamide, N-(1,1-dimethyl-3-oxobutyl)(meth)acrylamide, N-(hydroxymethyl)(meth)acrylamide, N-(3-methoxypropyl)(meth)acrylamide, N-(butoxymethyl)(meth)acrylamide, N-(isobutoxymethyl)acryl(meth)acrylamide, N-[tris(hydroxymethyl)methyl]acryl(meth)acrylamide, 7-[4-(trifluoromethyl)coumarin](meth)acrylamide, 3-(3-fluorophenyl)-2-propenamide, 3-(4-methylphenyl)(meth)acrylamide, N-(tert-butyl)(meth)acrylamide, and combinations thereof. These monomers can be polymerized with acrylic monomers, listed above. General formula for vinyl(form)amides are:

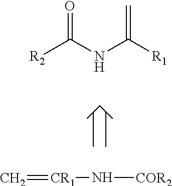

and (meth)acrylamides:

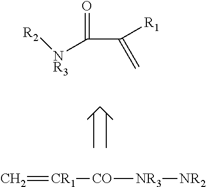

where R1 and R2 can be —H, —CH₃, —CH₂CH₃, and other substituted organic functional groups and R3 can by —H, an alkyl or an aryl.

In one embodiment, styrene monomers, such as styrene, methylstyrene, chlorostyrene, methoxystyrene and the like, are preferably co-polymerized with (meth)acrylamide monomers.

In one embodiment, the aqueous latex polymer may also comprise vinyl monomers. Monomers of this type suitable for use in accordance with the present invention include any compounds having vinyl functionality, i.e., —CH═CH₂ group. Preferably, the vinyl monomers are selected from the group consisting of vinyl esters, vinyl aromatic hydrocarbons, vinyl aliphatic hydrocarbons, vinyl alkyl ethers and mixtures thereof.

Suitable vinyl monomers include vinyl esters, such as, for example, vinyl acetate, vinyl propionate, vinyl laurate, vinyl pivalate, vinyl nonanoate, vinyl decanoate, vinyl neodecanoate, vinyl butyrates, vinyl caproate, vinyl benzoates, vinyl isopropyl acetates and similar vinyl esters; nitrile monomers, such (meth)acrylonitrile and the like; vinyl aromatic hydrocarbons, such as, for example, styrene, methyl styrenes and similar lower alkyl styrenes, chlorostyrene, vinyl toluene, vinyl naphthalene and divinyl benzene; vinyl aliphatic hydrocarbon monomers, such as, for example, vinyl chloride and vinylidene chloride as well as alpha olefins such as, for example, ethylene, propylene, isobutylene, as well as conjugated dienes such as 1,3-butadiene, methyl-2-butadiene, 1,3-piperylene, 2,3-dimethyl butadiene, isoprene, cyclohexene, cyclopentadiene, and dicyclopentadiene; and vinyl alkyl ethers, such as, for example, methyl vinyl ether, isopropyl vinyl ether, n-butyl vinyl ether, and isobutyl vinyl ether.

Additives including surfactants, initiators, chaser solutions, biocides, rheological modifiers, etc. can be added to the polymerization process.

Surfactants are described in “Additives Reference Guide” by J. V. Koleske, R. Springate and D. Brezinski at pp. 83-88 (2013), and these pages are incorporated herein in their entirety. The following discussion of surfactants are based on Koleske et al.

Nonionic surfactants usually refer to polyoxyethylene derivatives although other surfactants are included in this category. They are usually prepared by the addition reaction of ethylene oxide to hydrophobic compounds that contain one or more active hydrogen atoms. Examples of such hydrophobic compounds are fatty alcohols, alkylphenols, fatty acids, fatty amine, alkanolamines, fatty mercaptans, fatty amines and certain polyols. The polyols can include oxypropylene polyols, polyesters, and the like. These surfactants do not carry a charge nor do they dissociate. Their surface-active character comes from the oxyethylene portion of the molecule. Both the nature of the hydrophobe and the length of the oxyethylene chain have an effect on the surface-active character.

Overall, these groups are weakly hydrophilic in comparison to the hydrophobic portion of the molecule. Also present in many nonionic surfactants are weak ester and amide linkages. Nonionic surfactants are generally compatible with ionic surfactants. For example, many nonionic surfactants function well with anionic surfactants. In such combinations, they impart good freeze-thaw stability to aqueous systems and are less deleterious to mechanical properties than the ionic compounds. Nonylphenol ethoxylate (NPE) is a typical example of such surfactants. Other examples are: octylphenol ethoxylates (OPE), secondary alcohol ethoxylates, trimethyl nonanol ethoxylates (TMN), specialty alkoxylates, and amine ethoxylates. In emulsion polymerization, alkyl ether sulfates are one of the major surfactants necessary to provide for the stabilization of micelles. Traditionally, these sulfates have been based on alkylphenol ethoxylates (APEOs). Typically, emulsion polymerization uses two types of surfactants—one nonionic and the other anionic. Each provides separate stabilization mechanisms for the micelles, but the combination provides better stabilization, especially as temperature increases. The nonionic surfactants bestow a steric separation between micelle groups, while anionic surfactants yield a charged repulsion between the micelles. Nonionic surfactants generally perform well over a range of pH values, and they will usually foam less than anionic and cationic surfactants. However, nonionic surfactants may not lower the surface tension as well as anionic or cationic surfactants in complex coating formulations. There are nonionic polymeric fluorochemical surfactants that provide low surface tensions in organic coating systems. The lower the surface tension, the more effectively a coating wets, levels and spreads. Consequently, these are excellent wetting, leveling and flow control agents for a variety of waterborne, solvent borne and high solids coatings systems. Most of the fluoro-surfactants are soluble and compatible with most polymers and continue to be active throughout the drying or curing process. When used in waterborne systems, they tend to reduce the aqueous/organic interfacial tension and remain surface active in the organic portion of the polymer system. There is also an anionic fluoro-surfactant on the market based on ammonium salt, which is soluble in water.

Anionic surfactants carry a negative charge on the hydrophilic portion of the molecule. They are usually phosphates, sulfates and sulfonates. These surfactants may or may not contain an oxyethylene chain in their structure. Examples of anionic surfactants are sulfosuccinates, dioctyl sulfosuccinate (DOSS), polyether sulfates, polyether sulfonates, polyether phosphates, sodium lauryl sulfate and phosphate ester-modified alcohol-ethoxylates.

Surface-active phosphate esters are a class of anionic surfactants prepared by the reaction of alcohols with an activated phosphoric acid derivative—including phosphoric acid anhydrides and acid chlorides. Typically, phosphate ester commercial products are composed of a mixture of monoester, diester, free-phosphoric acid and free alcohol used in its preparation. The property of the final phosphate ester product is primarily defined by the starting alcohol used as well as on the composition of the four different species. Conversely, the property of the final phosphate product can be tailor-made by altering the alcohol used in the preparation as well as controlling the ratio of the four different components present in the final product. Phosphate ester surfactants are made in the free-acid form, but can also be neutralized to the salt form using any base including sodium hydroxide, potassium hydroxide, ammonium hydroxide or any organic amine.

Typically, the phosphate ester surfactants are added into the formulation during paint manufacture—added either in the grind or letdown depending upon the formulation. These additives have also been tested as post-paint formulation additives and have exhibited comparable properties. It has been speculated, and is the focus of a number of investigations, that use of the phosphate ester surfactant before the paint formulation stage—use of phosphate esters in emulsion polymerization as well as post polymerization stabilizer or additive in pigment dispersion—should only benefit the final property of the paint as well as reduce the detrimental effects of additional surfactants into the paint system.

Cationic surfactants carry a positive charge and quaternary ammonium compounds are the most common cationic surfactants. Compounds such as alkyl trimethyl ammonium chloride typify these surfactants.

The Hydrophilic Lipophilic Balance, HLB, system is a numbering system for rating the relative hydrophilic nature of a surfactant. The system is based on an arbitrary numerical scale where zero is assigned to a surfactant that is overwhelmingly hydrophobic and 20 is assigned to a surfactant that is overwhelmingly hydrophilic. The number assigned to the surfactant represents a measure of the balance between its hydrophilic and hydrophobic strengths. A surfactant with an HLB of 10 has an equal balance of oil-loving and water-loving groups.

Examples of initiators and chaser solutions useful in the polymerization process may include, but are not limited to, ammonium persulfate, sodium persulfate, azo initiators such as azoisobutyronitrile, redox systems such as sodium hydroxymethanesulfinate (sodium formaldehyde sulfoxylate; reducer) and t-butyl-hydroperoxide (oxidizer), and the like, and combinations thereof, typically in an aqueous solution. Either or both of these components can optionally contain an additional surfactant and/or a pH adjuster, if desired to stabilize the emulsion.

Examples of pH adjusters useful in the polymerization process may include, but are not limited to, ammonium hydroxide, sodium hydroxide, sodium carbonate, sodium bicarbonate, potassium hydroxide, potassium carbonate, potassium bicarbonate, ammonia, amines such as trimethylamine, triethylamine, dimethylaminoethanol, diethylaminoethanol, AMP-95 and the like, and combinations thereof. In certain cases, compounds that qualify as pH adjusters can be added for purposes other than adjusting pH, e.g., emulsion stabilization, and yet are still characterized herein as pH adjusters.

Polymer molecular weight control agents are designed to control (usually to limit) the molecular weight of a propagating polymer. While polymer molecular weight control agents may include things like radiation, they are typically molecules added to the polymerization mixture. Examples of polymer molecular weight control agents include, but are not limited to, chain transfer agents (CTAs), e.g., alkyl mercapto-esters such as isooctyl mercaptopropionate, alkyl mercaptans, and the like, and combinations thereof. Chain transfer agents typically operate as polymer molecular weight control agent molecules, for example, by catalytically or consumptively terminating a propagating polymer chain in a way that also initiates a newly propagating polymer chain. In this way, the amount of chain transfer agent(s) can be tailored to reduce the target polymer molecular weight in a set polymerization system, or alternately, in combination with calculation of the amount of initiator, can be calculated to target a particular average polymer molecular weight (e.g., within a given range) of a polymerization system.

While it is apparent that the illustrative embodiments of the invention disclosed herein fulfill the objectives stated above, it is appreciated that numerous modifications and other embodiments may be devised by those skilled in the art. Therefore, it will be understood that the appended claims are intended to cover all such modifications and embodiments, which would come within the spirit and scope of the present invention.

1. A substantially nonionic latex resin polymerized from:
a monomer mixture comprising at least one nonionic (meth)acrylate monomer, a polymerizable nonionic hydrophilic component, wherein the monomer mixture comprises less than 0.25 wt. % of acid monomer or other monomers with anionic groups, and
a nonionic surfactant ranging from about 1 wt. % to about 4 wt. %; and
wherein the polymerizable hydrophilic component is present from about 1.5 wt. % to about 3.5 wt. %,
wherein the weight percentages are without water, and
wherein the polymerizable hydrophilic component comprises a polymerizable polyethylene glycol monomer or a polymerizable polypropylene glycol monomer.

2. A substantially nonionic latex resin polymerized from:
a monomer mixture comprising at least one nonionic (meth)acrylate monomer, a polymerizable nonionic hydrophilic component, wherein the monomer mixture is comprises less than 0.25 wt. % of acid monomer or other monomers with anionic groups, and
a nonionic surfactant ranging from about 1 wt. % to about 4.5 wt. %, wherein a HLB value of the nonionic surfactant ranges from about 14 to about 18,
wherein the polymerizable hydrophilic component is present from about 1 wt. % to about 5 wt. %,
wherein the weight percentages are without water, and
wherein the polymerizable hydrophilic component comprises a polymerizable polyethylene glycol monomer or a polymerizable polypropylene glycol monomer.

3. The substantially nonionic latex resin of claim 2, wherein the monomer mixture comprises no acid monomer or other monomers with anionic groups.

4. The substantially nonionic latex resin of claim 2, wherein the acid monomer or other monomers with anionic groups are less than 0.125 wt. % of total monomer content.

5. The substantially nonionic latex resin of claim 2 further comprising an anionic surfactant in a seeding amount ranging from about 0.01 wt. % to about 0.25 wt. % based on total monomer content.

6. The substantially nonionic latex resin of claim 2, wherein the anionic surfactant ranges from about 0.035 wt. % to about 0.15 wt. % based on total monomer content.

7. (canceled)

8. The substantially nonionic latex resin of claim 2, wherein the polymerizable polyethylene glycol monomer is a methoxypolyethylene glycol methacrylate monomer.

9. The substantially nonionic latex resin of claim 1, wherein a HLB value of the nonionic surfactant ranges from about 14 to about 18.

10. The substantially nonionic latex resin of claim 2, wherein only nonionic surfactant is used in the polymerization to form micelles and the substantially nonionic latex resin.

11. A paint or architectural composition comprising
at least one cationic additive, and
a substantially nonionic latex resin polymerized from:
a monomer mixture comprising at least one nonionic (meth)acrylate monomer, a polymerizable nonionic hydrophilic component, wherein the monomer mixture is substantially free of acid monomer or other monomers with anionic groups, and
a nonionic surfactant ranging from about 1 wt. % to about 4.5 wt. %, wherein a HLB value of the nonionic surfactant ranges from about 14 to about 18,
wherein the polymerizable hydrophilic component is present from about 1 wt. % to about 5 wt. %,
wherein the weight percentages of the substantially nonionic latex resin are without water.

12. The paint or architectural composition of claim 11, wherein the cationic additive is present from 1.0 wt. % to 6.0 wt. %, preferably from 2.0 wt. % to 4.5 wt. % or from 2.5 wt. % to 3.5 wt. % of the paint or architectural composition,
wherein the weight percentage of cationic additive to architectural composition includes water.

13. The paint or architectural composition of claim 11, wherein the cationic additive has at least one positively charged metal ion.

14. The paint or architectural composition of claim 13, wherein the at least one charged metal ion is an aluminum cation or a zirconium cation.

15. The paint or architectural composition of claim 11, wherein the cationic additive comprises at least one of poly(aluminum hydroxy)chloride, polymeric cationic quaternary amines, a blend of didecyl dimethyl ammonium carbonate and didecyl dimethyl ammonium bicarbonate, aluminum hydroxide, zirconium silicate, ammonium zirconium carbonate, potassium zirconium carbonate, and zinc strontium calcium phosphosilicate.

16. The paint or architectural composition of claim 11 further comprising an acid.

17. The paint or architectural composition of claim 16, wherein the acid comprises a citric acid or a gluconic acid sodium salt.

18. The paint or architectural composition of claim 16, wherein the acid is present from about 0.25 wt. % to about 2.0 wt. %,
wherein the weight percentage of acid to architectural composition includes water.

19. A method for polymerizing a nonionic resin, wherein the nonionic resin comprises less than 0.25 wt. % of acid monomer, said method comprises the step of:
polymerizing at least one or more film forming nonionic monomer and a polymerizable hydrophilic component with at least one nonionic surfactant,
wherein a nonionic surfactant ranging from about 1 wt. % to about 4.5 wt. %,
wherein the polymerizable hydrophilic component is present from about 1 wt. % to about 5 wt. %,
wherein the weight percentages are without water.

20. The method of claim 19 further comprising the step of:
preparing a seed for the nonionic resin using a seeding amount of anionic surfactant, wherein the seeding mount ranges from about 0.01 wt. % to about 0.25 wt. %, based on total monomer content.
